(19) United States
(12) Patent Application Publication
(10) Pub. No.: US 2024/0133497 A1
(43) Pub. Date: Apr. 25, 2024

(54) NUT GUIDE

(71) Applicant: PETRÓLEO BRASILEIRO S.A. - PETROBRAS, Rio de Janeiro (BR)

(72) Inventor: CARLOS AMERICO VEIGA DAMASCENO, JR., MACAÉ (BR)

(73) Assignee: PETRÓLEO BRASILEIRO S.A. - PETROBRAS, Rio de Janeiro (BR)

(21) Appl. No.: 18/493,125

(22) Filed: Oct. 23, 2023

(30) Foreign Application Priority Data
Oct. 24, 2022 (BR) 1020220216100

(51) Int. Cl. F16L 23/00

(52) U.S. Cl. CPC F16L 23/003; E21B 43/01

(57) ABSTRACT

The present invention aims at solving the difficulty of coupling a subsea torque tool, which is usually used by ROVs, to the nuts of cases used to join flanges in pipelines and pipes. In this way, a nut guide (3) is proposed, which is used in pre-assembly and which is coupled to the nut (2) through an adhesive means or any other appropriate joining means, wherein the torque tool is quickly and smoothly guided to the ideal position for tightening or loosening the flanges by using the screw (1) and nut (2) assembly, facilitating the fitting and minimizing the number of alignment maneuvers between the torque tool and the nut (2).

### CROSS-REFERENCE TO RELATED APPLICATION

This application claims, under 35 U.S.C. § 119(a), priority to and the benefit of Brazilian Patent Application No. 10 2022 021610 0, filed Oct. 25, 2022, which is incorporated by reference herein in its entirety.

### FIELD OF THE INVENTION

The present invention applies to the petrochemical field, from the perspective of the tools and materials used during the production step, more specifically, in relation to drilling and transport through subsea pipelines present in deep waters. Thus, the present invention discloses a nut guide for subsea connections to be carried out mainly by a remotely operated vehicle (ROV) and can be applied to all subsea connections that use nuts and cases with torque intended to be operated with the use of ROV.

### BACKGROUND OF THE INVENTION

During the assembly and maintenance operations of subsea equipment, upon realizing any need of acting on the screws present in the subsea pipelines, a remotely operated vehicle (ROV) is generally used for such a function, in which, in possession of a torque tool known as a “torquer”, the remote operator skillfully needs to correctly and safely attach such a tool to the used nuts, in order to tighten or loosen these nuts that are contained in the flange joints of the pipelines.

Due to the various degrees of freedom associated with the torque tools and the manipulator arm of ROVs, the task of coupling the torque tool to the nut becomes complex and time-consuming. Therefore, the time required to attach such a tool to the nuts and the guarantee of a good coupling is largely dependent on the skill of the ROV operator. Such a difficulty increases the costs of the service, which are often paid per minute for the use of the ships that operate the ROVs, resulting in a large portion of time consumed during the operation, since it cannot be guaranteed that the ROV operator will not need to do too many maneuvers to align and couple the torque tool to the nut.

### STATE OF THE ART

The state of the art discloses some literature related to the object of the present invention, such as document US20190030665, which discloses a system consisting of a star-shaped gear that moves between the screws of the flange, as shown in FIG. 3B of this document. However, the guide system mentioned in this document has no function of facilitating the fitting of a torque tool. The assembly presented in this document is a complex mechanism that is not an integral part of the screw, having an asterisk-shaped geometry with the purpose of moving a gear.

Document US20140286727 discloses a system proposed by a bushing for locking the nut. However, such a system has no guiding purpose and is embedded inside the nut. Furthermore, the geometry of the part has internal threads and a cylindrical shape.

### OBJECTIVES OF THE INVENTION

The flange joints applied to the subsea pipelines need to be unified, joining the pipelines to each other by using screws and nuts in a reliable manner, requiring periodic maintenance on these items.

Thus, the present invention aims at solving the difficulty of coupling a subsea torque tool, which is usually used by ROVs, to the nuts of cases used to join flanges in pipelines and pipes. In this way, a nut guide is proposed that is used in pre-assembly and that is coupled to the nut through an adhesive means or any other suitable joining means, wherein the torque tool is quickly and smoothly guided into the ideal position for tightening or loosening by means of the screw and nut assembly, facilitating the fitting and minimizing the number of alignment maneuvers between the torque tool and the nut.

The proposed invention is centrally concerned with reducing the time spent and improving the coupling of the torque tool to the nuts contained in the flange joint, in which this operation comprises considerably different particularities in relation to what was previously proposed in the state of the art. More specifically, the proposed invention allows, briefly, to carry out the aforementioned coupling, in which the solution is the coupling of the nut guide to the nut, wherein the nut guide assembly coupled to the nut moves as a single element between the screws of the flange.

### BRIEF DESCRIPTION OF THE FIGURES

FIG. 1 illustrates a conventional screw and nut assembly.

FIG. 2 illustrates the nut guide that is the object of the present invention.

FIG. 3 illustrates the screw and nut assembly with the nut guide inserted.

### DETAILED DESCRIPTION OF THE INVENTION

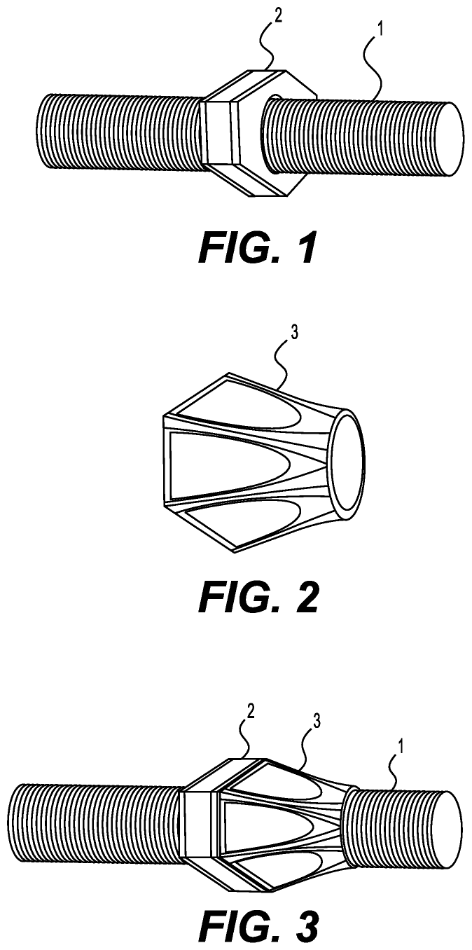

The present invention aims at solving the difficulty of coupling a subsea torque tool, which is usually used by ROVs, to the nuts of cases used to join flanges in pipelines and pipes. In this way, a nut guide 3 is proposed, which is used in pre-assembly and is coupled to nut 2, wherein the torque tool is quickly and smoothly guided to the position for tightening or loosening through the screw 1 and nut 2 assembly (illustrated in FIG. 1), facilitating the fitting and minimizing the number of alignment maneuvers between the torque tool and nut 2.

The proposed invention allows, briefly, to carry out such a coupling between the torque tool and the nut 2, wherein the nut guide assembly 3, coupled to the nut 2, moves as a single element between the screws of the flange.

The nut guide 3, as can be seen in FIG. 2, can be manufactured from a polymeric material, but is not limited to this type of material.

The coupling between the nut guide 3 and the nut 2 can be done through an adhesive means or any other joining means that is appropriate, in order to ensure that the nut guide 3 and nut 2 assembly remains fastened in a secure way.

Thus, the nut guide 3 is responsible for gradually guiding the coupling of the torque tool to the nut 2. Its general conical shape discloses the ease of approximation and initial alignment with the nut 2, avoiding more time spent and excessive alignment maneuvers by the operator.

Once the nut guide 3 is coupled to the nut 2 in the pre-assembly, as can be noted in FIG. 3, if there is the need of tightening or removing the nut 2, the coupling to be made between the torque tool and nut 2 will occur in a more agile, quick and smooth way, since the tool will be gradually guided by the geometry of the nut guide 3, which goes smoothly from the conical shape at one of its ends to the hexagonal shape at the other end, as illustrated in FIG. 2, thus preventing the operator from swinging or inadvertently moving.

1. A nut guide, comprising a geometry that transitions from a conical shape at a first end to a hexagonal shape at a second end.

2. The nut guide according to claim 1, wherein the nut guide is configured to couple to a nut (using an adhesive material.

3. The nut guide according to claim 1, wherein the nut guide comprises a polymeric material.

4. The nut guide according to claim 1, wherein the nut guide, coupled to the nut, is configured to move as a single element between screws of a flange.
